(19) United States
(12) Patent Application Publication
(10) Pub. No.: US 2018/0002139 A1
(43) Pub. Date: Jan. 4, 2018

(54) ADJUSTABLE HANDRAIL SYSTEM FOR A TOP OF AN ELEVATOR CAR AND METHOD OF ADJUSTING

(71) Applicant: Otis Elevator Company, Farmington, CT (US)

(72) Inventors: Jerry L. Stepp, Florence, SC (US); Jesus Valenzuela Buentello, Florence, SC (US)

(21) Appl. No.: 15/633,151

(22) Filed: Jun. 26, 2017

Related U.S. Application Data
(60) Provisional application No. 62/356,224, filed on Jun. 29, 2016.

(51) Int. Cl. B66B 5/00; B66B 11/02

(52) U.S. Cl. CPC B66B 5/0081; B66B 11/0226; B66B 5/005

(57) ABSTRACT

An adjustable handrail system for a top region of an elevator car includes a first stationary post fixed to a top surface of the elevator car and extending upwardly therefrom along a first longitudinal axis. Also included is a second stationary post fixed to the top surface of the elevator car and extending upwardly therefrom along a second longitudinal axis, the first and second stationary posts spaced from each other and oriented parallel to each other. Further included is an adjustable handrail panel translatable between a first position and a second position, the adjustable handrail panel operatively coupled to the first stationary post and the second stationary post and translatable perpendicularly relative to the first and second longitudinal axes and parallel to the top surface of the elevator car.

### CROSS-REFERENCE TO RELATED APPLICATIONS

This patent application claims the benefit of priority to U.S. Provisional Patent Application Ser. No. 62/356,224, filed Jun. 29, 2016, which is incorporated herein by reference in its entirety.

### BACKGROUND

The embodiments herein relate to elevator systems and, more particularly, to an adjustable handrail system for the top of an elevator car of such systems, as well as a method associated therewith.

Elevator car roof railings typically are generally erected and/or folded by the operator standing on the car roof, so that the operator must take particular care to properly and safely fold the railing sides. One situation where the handrail is useful is while personnel are on top of the elevator car to access control equipment mounted in the hoistway.

The handrail system may be erected into position, but when the operator has little work to do on the car roof, he may be tempted not to erect the railing and this is a hazardous situation. Alternatively, the handrail system may be erected with the ability to fold the handrail down, but it is difficult to provide a handrail that does not encroach into the prescribed minimum controller servicing zone due to limited available hoistway space. Therefore, providing a minimum clearance between handrail components and other elevator system components, while allowing an operator easy and safe access to hoistway mounted equipment is challenging to achieve in combination.

### BRIEF DESCRIPTION

According to one embodiment, an adjustable handrail system for a top region of an elevator car includes a first stationary post fixed to a top surface of the elevator car and extending upwardly therefrom along a first longitudinal axis. Also included is a second stationary post fixed to the top surface of the elevator car and extending upwardly therefrom along a second longitudinal axis, the first and second stationary posts spaced from each other and oriented parallel to each other. Further included is an adjustable handrail panel translatable between a first position and a second position, the adjustable handrail panel operatively coupled to the first stationary post and the second stationary post and translatable perpendicularly relative to the first and second longitudinal axes and parallel to the top surface of the elevator car.

In addition to one or more of the features described above, or as an alternative, further embodiments may include a first slide bracket fixed to the adjustable handrail panel proximate a first end of the first slide bracket, the first slide bracket defining a first slot. Also included is a first slide support pin extending through the first slot and slidably disposed therein, the first slide support pin secured to the first stationary post to operatively couple the adjustable handrail panel to the first stationary post. Further included is a second slide bracket fixed to the adjustable handrail panel proximate a first end of the second slide bracket, the second slide bracket defining a second slot. Yet further included is a second slide support pin extending through the second slot and slidably disposed therein, the second slide support pin secured to the second stationary post to operatively couple the adjustable handrail panel to the second stationary post.

In addition to one or more of the features described above, or as an alternative, further embodiments may include that the first slide bracket and the second slide bracket are each operatively coupled to the adjustable handrail panel proximate a top edge of the adjustable handrail panel. The adjustable handrail system may also include a third slide bracket fixed to the adjustable handrail panel proximate a first end of the third slide bracket and proximate a lower edge of the adjustable handrail panel, the third slide bracket defining a third slot. Further included is a third slide support pin extending through the third slot and slidably disposed therein, the third slide support pin secured to the first stationary post to operatively couple the adjustable handrail panel to the first stationary post. Yet further included is a fourth slide bracket fixed to the adjustable handrail panel proximate a first end of the fourth slide bracket and proximate a lower edge of the adjustable handrail panel, the fourth slide bracket defining a fourth slot. Also included is a fourth slide support pin extending through the fourth slot and slidably disposed therein, the fourth slide support pin secured to the second stationary post to operatively couple the adjustable handrail panel to the second stationary post.

In addition to one or more of the features described above, or as an alternative, further embodiments may include a lock pin extendable through an aperture defined by one of the first stationary post and the second stationary post and through one of a plurality of slide bracket apertures defined by one of the first slide bracket and the second slide bracket, the lock pin fixing the adjustable handrail panel in the first position or the second position in an inserted condition.

In addition to one or more of the features described above, or as an alternative, further embodiments may include that the adjustable handrail panel is not rotatable.

In addition to one or more of the features described above, or as an alternative, further embodiments may include at least one intermediate position that the adjustable handrail may be translated to and fixed at, the at least one intermediate position located between the first position and the second position.

In addition to one or more of the features described above, or as an alternative, further embodiments may include that the elevator car has a front side, a rear side, a first side and a second side, the adjustable handrail system disposed on the top surface of the elevator car and proximate the first side, the adjustable handrail panel translatable toward and away from the second side.

In addition to one or more of the features described above, or as an alternative, further embodiments may include that the adjustable handrail system is translatable to access equipment mounted to a hoistway wall that the elevator car moves within.

In addition to one or more of the features described above, or as an alternative, further embodiments may include that the equipment mounted to the hoistway wall is an elevator system controller.

In addition to one or more of the features described above, or as an alternative, further embodiments may include that the first position of the adjustable handrail panel is a normal operating position and the second position is a controller servicing position.

According to another embodiment, a method of adjusting a handrail panel on a top of an elevator car is provided. The method includes unlocking the handrail panel. The method also includes translating the handrail panel between a first position and a second position, the handrail panel operatively coupled to a first stationary post and a second stationary post, the first and second stationary posts each fixed to a top surface of the elevator car and extending upwardly therefrom along respective longitudinal axes, wherein translating the handrail panel is made perpendicularly relative to the first and second longitudinal axes.

In addition to one or more of the features described above, or as an alternative, further embodiments may include that translating the handrail panel comprises sliding the handrail panel relative to the first and second stationary posts with a first slide bracket operatively coupling the handrail panel to the first stationary post and a second slide bracket operatively coupling the handrail panel to the second stationary post, the slide brackets each defining a respective slot having a slide pin disposed therein and secured to the respective stationary post, the slide pin slidable within the slot.

In addition to one or more of the features described above, or as an alternative, further embodiments may include that unlocking the handrail panel comprises removing a repeatedly insertable lock pin through one of a plurality of apertures of one of the first and second stationary posts and through one of a plurality of apertures of the slide bracket.

In addition to one or more of the features described above, or as an alternative, further embodiments may include that the handrail panel is adjustable to access an elevator system controller mounted to a hoistway wall of a hoistway that the elevator car moves within.

In addition to one or more of the features described above, or as an alternative, further embodiments may include that the first position of the handrail panel is a normal operating position to provide clearance between the handrail panel and other components within the hoistway and the second position is a controller servicing position.

### BRIEF DESCRIPTION OF THE DRAWINGS

The subject matter which is regarded as the disclosure is particularly pointed out and distinctly claimed in the claims at the conclusion of the specification. The foregoing and other features and advantages of the disclosure are apparent from the following detailed description taken in conjunction with the accompanying drawings in which:

FIG. 1 is a perspective view of a top region of an elevator car;

FIG. 2 is a perspective view of an adjustable handrail system of the elevator car in a first position;

FIG. 3 is a perspective view of the adjustable handrail system in a second position;

FIG. 4 is a perspective view of a portion of the adjustable handrail system;

FIG. 5 is a perspective view of a slide bracket of the adjustable handrail system;

FIG. 6 is a perspective view of a slide support pin of the adjustable handrail system;

FIG. 7 is a perspective view of a lock pin of the adjustable handrail system prior to engagement; and

FIG. 8 is a perspective view of the lock pin in an engaged condition.

### DETAILED DESCRIPTION

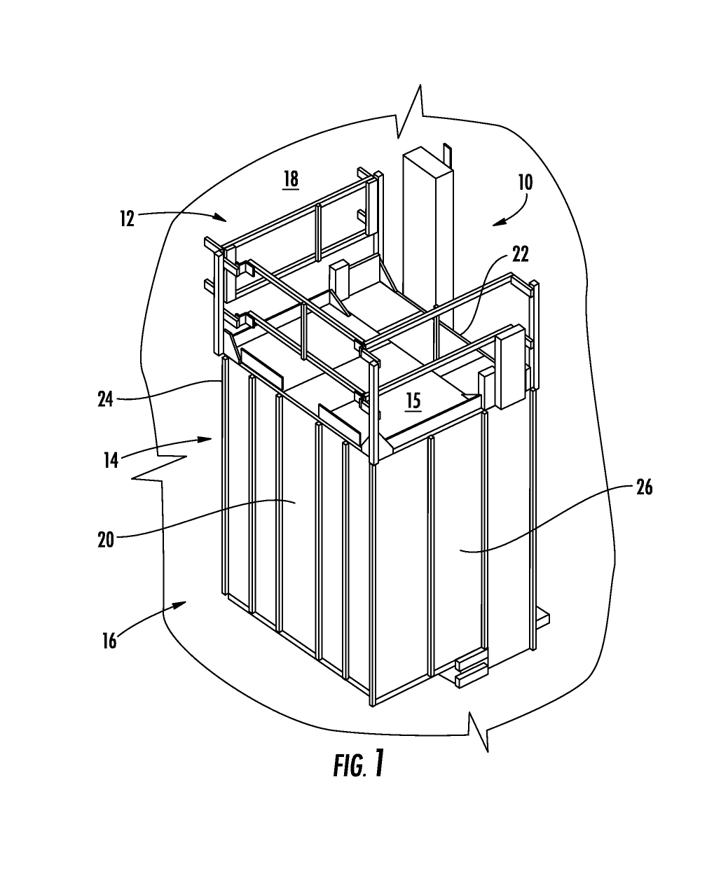

Referring to FIG. 1, a portion of an elevator system is illustrated and referenced generally with numeral 10. The embodiments described herein relate to an adjustable handrail system 12 for an elevator car 14 of the elevator system 10.

The elevator car 14 is moveable within a hoistway 16 defined by hoistway walls 18, as partially illustrated. The adjustable handrail system 12 can be used with various types of elevator systems. For example, the embodiments described herein may be used with roped or ropeless elevator systems. Regardless of what type of elevator system the adjustable handrail system 12 is used with, the system 12 is disposed on a top region of the elevator car 14. In particular, the adjustable handrail system 12 is operatively coupled to, and extends upwardly from, a top surface 15 of the elevator car 14. As shown, the elevator car 14 includes a front side 22, a rear side 20, a first side 24 and a second side 26. In the illustrated embodiment, the adjustable handrail system 12 extends along, and is disposed in close proximity to, the first side 24 of the elevator car 14. The embodiments of the adjustable handrail system 12 may be located on either the first side 24 or the second side 26. Additionally, the system 12 may be located on both the first side 24 and the second side 26. The system 12, combined with other handrail features that may be fixed (i.e., non-moveable) form a space that is surrounded with a handrail structure surrounding the operator standing on the elevator car 14 for safety purposes.

As will be appreciated from the description herein, the system 12 is translatable to allow an operator standing on a top surface 15 of the elevator car to simply slide a portion of the adjustable handrail system 12 between different positions for servicing purposes, while maintaining the top of the handrail system 12 at a consistent height that is considered safe, thereby avoiding disadvantages associated with handrail systems that are collapsible or may be translated or rotated downwardly. While the handrail system 12 is kept at the above-described consistent height, a specified clearance between the handrail system components and objects that the elevator car 14 will pass within the hoistway 16 during normal operation of the elevator car 14 is required. This clearance will vary depending upon the particular application. Therefore, the handrail system 12 must be sufficiently “inboard” on the elevator car 14 to meet the clearance requirement, while also allowing an operator to conveniently access equipment mounted on one or more of the hoistway walls 18. For example, a system controller may be mounted in such a way that requires an operator to stand on the top surface 15 of the elevator car 14 to perform required tasks with the equipment. The embodiments of the adjustable handrail system 12 described herein advantageously address the above-described issues, while conveniently maintaining the handrail system at a consistent height.

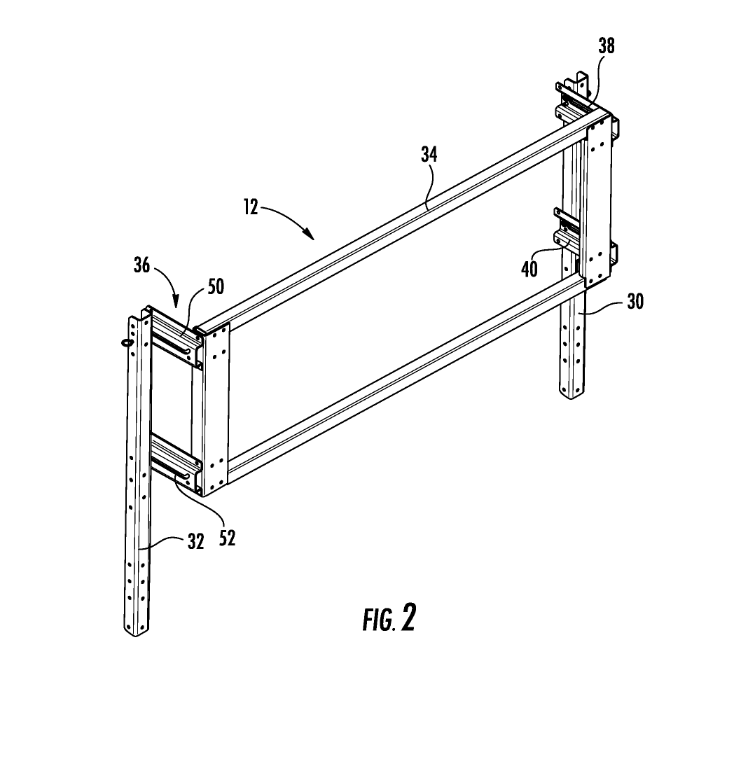

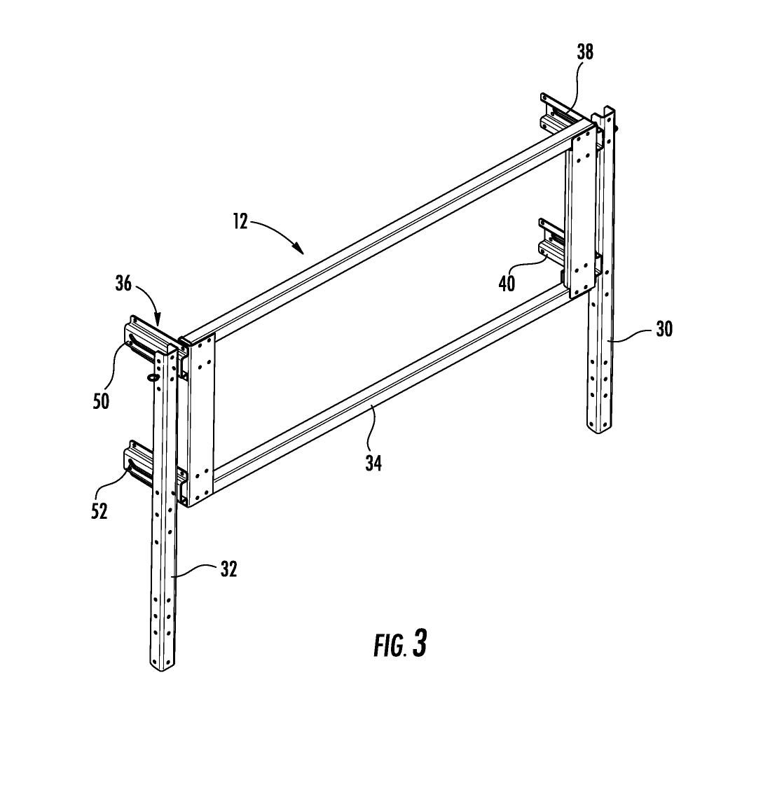

Referring now to FIGS. 2 and 3, the adjustable handrail system 12 is illustrated in greater detail. The system 12 includes a portion that is translatable between two discrete positions that are lockable, specifically a first position (FIG. 2) and a second position (FIG. 3). It is contemplated that the adjustable handrail system 12 may be translated, and locked, to one or more intermediate positions between the first position and the second position in some embodiments. The adjustable handrail system 12 includes a first stationary post 30 fixed to the top surface 15 of the elevator car 14 and extending upwardly therefrom along a first axis. Similarly, a second stationary post 32 is fixed to the top surface 15 and extends upwardly therefrom along a second axis. The first and second stationary posts 30, 32 are spaced from each other and oriented parallel to each other. In some embodiments, the stationary posts 30, 32 are positioned proximate respective corners of the top surface 15, as shown in FIG. 1. An adjustable handrail panel 34 is operatively coupled to the stationary posts 30, 32 in a translatable manner. In particular, the adjustable handrail panel 34 is translatable between the first position (FIG. 2) and the second position (FIG. 3).

The first position shown in FIG. 2 may be referred to as a normal operating position. This position is beneficial during normal movement of the elevator car 14. As shown, the adjustable handrail panel 34 has been translated to an inboard position of the region above the elevator car 14. This retracted position accommodates the clearance requirements described above. In particular, all portions of the adjustable handrail panel 34 are located flush with the side of the elevator car 14, or inboard thereof.

The second position shown in FIG. 3 may be referred to as an equipment servicing position, or controller servicing position in such embodiments. The movement between the first and second positions is achieved by allowing the adjustable handrail panel 34 to be translatable perpendicularly relative to the first and second longitudinal axes and parallel to the top surface 15 of the elevator car 14. In other words, the adjustable handrail panel 34 is translatable toward and away from the first and second sides 24, 26 of the elevator car 14. In the second position, the adjustable handrail panel 34 is at least flush with the side of the elevator car 14, or outboard thereof.

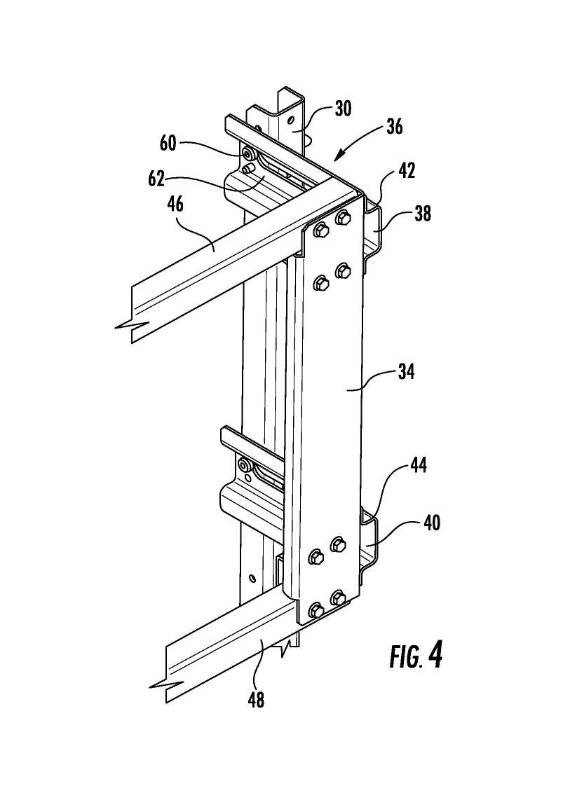

Referring now to FIGS. 4-6, the coupling, and sliding, relationship between the adjustable handrail panel 34 and the stationary posts is illustrated in greater detail. A single coupling between the adjustable handrail panel 34 and the first stationary post 32 is illustrated for purposes of description, but it is to be appreciated that an identical, mirrored-image, coupling is made between the adjustable handrail panel 34 and the second stationary post 30.

At least one slide bracket 36 is provided to operatively couple the adjustable handrail panel 34 to the first stationary post 32. In the illustrated embodiment, two slide brackets are illustrated to provide coupling that allows translation of the adjustable handrail panel 34. Specifically, the slide bracket(s) 36 comprises a first slide bracket 38 and a second slide bracket 40. The first slide bracket 38 is fixedly coupled to the adjustable handrail panel 34 proximate a first end 42 of the first slide bracket 38. The second slide bracket 40 is also fixedly coupled to the adjustable handrail panel 34 proximate a first end 44 of the second slide bracket 40. In some embodiments, such as that illustrated, the first and second slide brackets 38, 40 are coupled to the adjustable handrail panel 34 proximate a top edge 46 and a bottom edge 48 of the adjustable handrail panel 34, respectively. Similar connections between a third slide bracket 50 and a fourth slide bracket 52 may be made with the adjustable handrail panel 34 to couple the panel 34 to the second stationary post 32.

It is to be appreciated that a single slide panel may be provided at each end of the adjustable handrail panel 34 to couple the panel 34 to the stationary posts 30, 32. Alternatively, more than two slide brackets at each end may be employed. Regardless of the number of slide brackets included, each of the at least one slide brackets 36 defines a slot 54 extending along a longitudinal direction of the bracket 36 from a first end 56 of the slot 54 to a second end 58 of the slot 54. In some embodiments, the slot 54 is substantially straight along an entirety thereof. Alternatively, as illustrated, angled portions may be present at the first and/or second ends 56, 58 of the slot 54.

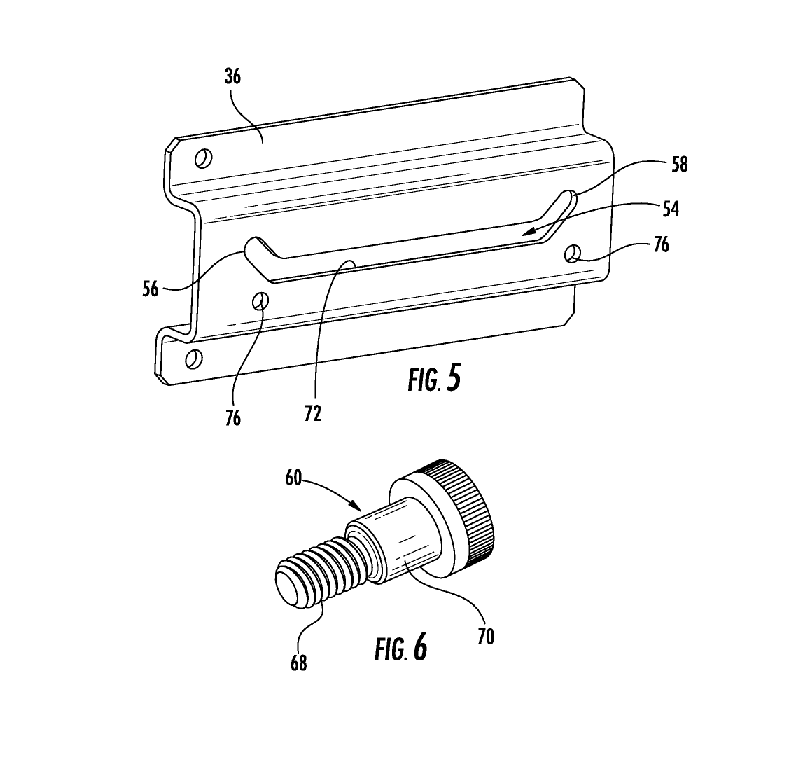

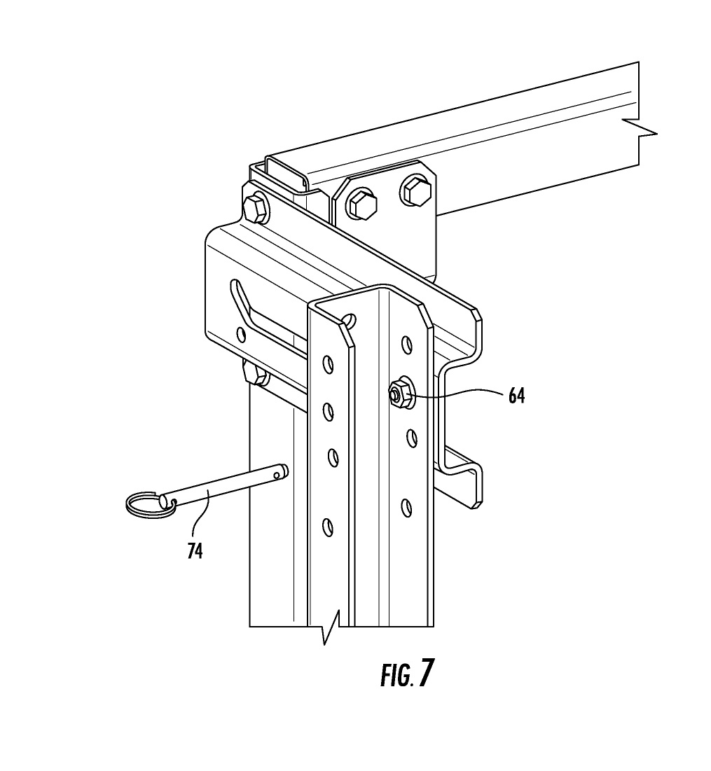

A slide support pin 60 extends through the slot 54 and is fixedly secured to the first stationary post 30. In particular, an oversized head of the slide support pin 60 prevents complete insertion through the slot 54 and is in contact with an inner surface 62 of the slide bracket 36. A distal end of the slide support pin 60 extends through an aperture of the first stationary post 30 and is secured thereto with a nut 64 or the like to prevent withdrawal of the slide support pin 60 (FIGS. 4 and 6). As shown in FIG. 6, the slide support pin 60 includes a threaded portion 68 to engage the nut 64 and a smooth portion 70 that is well-suited for repeated sliding engagement with slot walls 72 of the slide bracket 36 that define the slot 54. The smooth portion 70 may be made from, or coated with, a low friction material to enhance the above-described repeated sliding relative to the slot walls 72. Removal of the slide support pin 60 is not necessary to adjust the adjustable handrail panel 34 in a translatable manner.

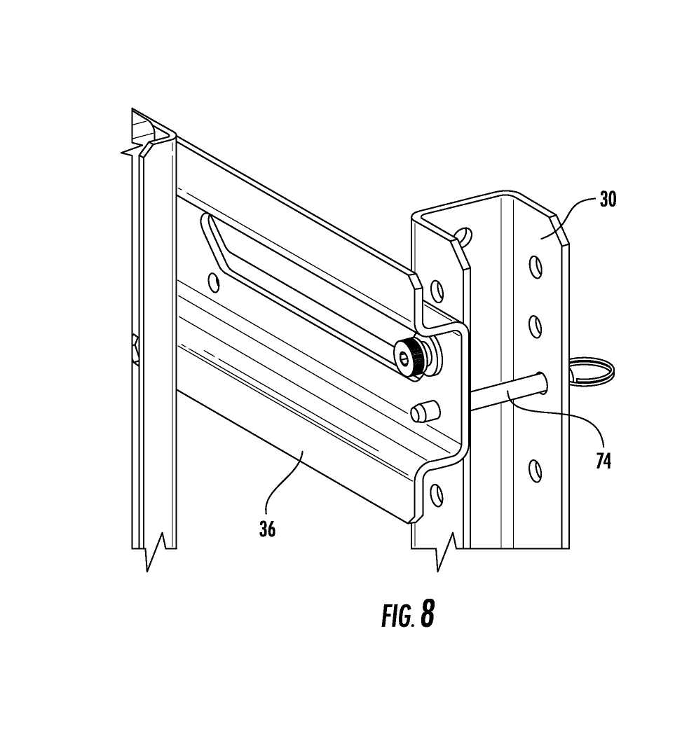

Referring now to FIGS. 7 and 8, a lock pin 74 is shown in a non-inserted condition (FIG. 7) that corresponds to an unlocked condition of the adjustable handrail panel 34 and an inserted condition (FIG. 8) that corresponds to a locked condition of the adjustable handrail panel 34. The lock pin 74 does not require threading in the illustrated embodiment. Rather, the lock pin 74 is simply inserted and removed in a repeatable manner into at least one aperture of the first stationary post 30 and/or the second stationary post 32 and the slide bracket 36 to lock and unlock the adjustable handrail panel 34 in the first or second position (and intermediate position(s) in some embodiments). Specifically, the first stationary post 30 or the second stationary post 32 defines at least one aperture sized to receive the lock pin 74. Locking may be done by insertion of the lock pin 74 through only one of the stationary posts or may be done by insertion through both for redundancy purposes. Regardless of which stationary post the lock pin 74 is inserted through, the lock pin 74 is further inserted through one of a plurality of lock pin apertures 76 (FIG. 5) defined by the slide bracket 36. In the illustrated embodiment of FIG. 5, only two lock pin apertures 76 are defined to account for the two discrete positions of the adjustable handrail panel 34. In operation, the adjustable handrail panel 34 is translated to one of the discrete positions in the unlocked condition (i.e., lock pin 74 removed) and subsequently the lock pin 74 is re-inserted to lock the adjustable handrail panel 34 in the desired position.

Advantageously, adjustment of the adjustable handrail system 12 is safe, simple and easily manageable by one person. The system 12 provides an adequate servicing zone when the elevator car 14 is disabled, while also being adjustable to provide required clearance between the handrails and adjacent hoistway mounted components and equipment while the elevator car is capable of moving within the hoistway. Additionally, the system 12 does not require rotating, or collapsing, the handrail panel to an alternate position when servicing equipment. Such an open handrail panel leaves an unguarded portion of the hoistway, creating a fall hazard in some conditions. In the embodiments described herein, a non-rotatable handrail panel is provided to maintain a consistent handrail height and enclosure, while accommodating the above-described clearance requirements.

While the disclosure has been described in detail in connection with only a limited number of embodiments, it should be readily understood that the disclosure is not limited to such disclosed embodiments. Rather, the disclosure can be modified to incorporate any number of variations, alterations, substitutions or equivalent arrangements not heretofore described, but which are commensurate with the spirit and scope of the disclosure. Additionally, while various embodiments of the disclosure have been described, it is to be understood that aspects of the disclosure may include only some of the described embodiments. Accordingly, the disclosure is not to be seen as limited by the foregoing description, but is only limited by the scope of the appended claims.

What is claimed is:

1. An adjustable handrail system for a top region of an elevator car comprising:
a first stationary post fixed to a top surface of the elevator car and extending upwardly therefrom along a first longitudinal axis;
a second stationary post fixed to the top surface of the elevator car and extending upwardly therefrom along a second longitudinal axis, the first and second stationary posts spaced from each other and oriented parallel to each other; and
an adjustable handrail panel translatable between a first position and a second position, the adjustable handrail panel operatively coupled to the first stationary post and the second stationary post and translatable perpendicularly relative to the first and second longitudinal axes and parallel to the top surface of the elevator car.

2. The adjustable handrail system of claim 1, further comprising:
a first slide bracket fixed to the adjustable handrail panel proximate a first end of the first slide bracket, the first slide bracket defining a first slot;
a first slide support pin extending through the first slot and slidably disposed therein, the first slide support pin secured to the first stationary post to operatively couple the adjustable handrail panel to the first stationary post;
a second slide bracket fixed to the adjustable handrail panel proximate a first end of the second slide bracket, the second slide bracket defining a second slot; and
a second slide support pin extending through the second slot and slidably disposed therein, the second slide support pin secured to the second stationary post to operatively couple the adjustable handrail panel to the second stationary post.

3. The adjustable handrail system of claim 2, wherein the first slide bracket and the second slide bracket are each operatively coupled to the adjustable handrail panel proximate a top edge of the adjustable handrail panel, the adjustable handrail system further comprising:
a third slide bracket fixed to the adjustable handrail panel proximate a first end of the third slide bracket and proximate a lower edge of the adjustable handrail panel, the third slide bracket defining a third slot;
a third slide support pin extending through the third slot and slidably disposed therein, the third slide support pin secured to the first stationary post to operatively couple the adjustable handrail panel to the first stationary post;
a fourth slide bracket fixed to the adjustable handrail panel proximate a first end of the fourth slide bracket and proximate a lower edge of the adjustable handrail panel, the fourth slide bracket defining a fourth slot; and
a fourth slide support pin extending through the fourth slot and slidably disposed therein, the fourth slide support pin secured to the second stationary post to operatively couple the adjustable handrail panel to the second stationary post.

4. The adjustable handrail system of claim 2, further comprising a lock pin extendable through an aperture defined by one of the first stationary post and the second stationary post and through one of a plurality of slide bracket apertures defined by one of the first slide bracket and the second slide bracket, the lock pin fixing the adjustable handrail panel in the first position or the second position in an inserted condition.

5. The adjustable handrail system of claim 1, wherein the adjustable handrail panel is not rotatable.

6. The adjustable handrail system of claim 1, further comprising at least one intermediate position that the adjustable handrail may be translated to and fixed at, the at least one intermediate position located between the first position and the second position.

7. The adjustable handrail system of claim 1, wherein the elevator car has a front side, a rear side, a first side and a second side, the adjustable handrail system disposed on the top surface of the elevator car and proximate the first side, the adjustable handrail panel translatable toward and away from the second side.

8. The adjustable handrail system of claim 1, wherein the adjustable handrail system is translatable to access equipment mounted to a hoistway wall that the elevator car moves within.

9. The adjustable handrail system of claim 8, wherein the equipment mounted to the hoistway wall is an elevator system controller.

10. The adjustable handrail system of claim 9, wherein the first position of the adjustable handrail panel is a normal operating position and the second position is a controller servicing position.

11. A method of adjusting a handrail panel on a top of an elevator car comprising:
unlocking the handrail panel; and
translating the handrail panel between a first position and a second position, the handrail panel operatively coupled to a first stationary post and a second stationary post, the first and second stationary posts each fixed to a top surface of the elevator car and extending upwardly therefrom along respective longitudinal axes, wherein translating the handrail panel is made perpendicularly relative to the first and second longitudinal axes.

12. The method of claim 11, wherein translating the handrail panel comprises sliding the handrail panel relative to the first and second stationary posts with a first slide bracket operatively coupling the handrail panel to the first stationary post and a second slide bracket operatively coupling the handrail panel to the second stationary post, the slide brackets each defining a respective slot having a slide pin disposed therein and secured to the respective stationary post, the slide pin slidable within the slot.

13. The method of claim 12, wherein unlocking the handrail panel comprises removing a repeatedly insertable lock pin through one of a plurality of apertures of one of the first and second stationary posts and through one of a plurality of apertures of the slide bracket.

14. The method of claim 11, wherein the handrail panel is adjustable to access an elevator system controller mounted to a hoistway wall of a hoistway that the elevator car moves within.

15. The method of claim 14, wherein the first position of the handrail panel is a normal operating position to provide clearance between the handrail panel and other components within the hoistway and the second position is a controller servicing position.
